(19) United States
(12) Patent Application Publication
(10) Pub. No.: US 2025/0181342 A1
(43) Pub. Date: Jun. 5, 2025

(54) CONTROLLER, CONTROL METHOD, AND NON-TRANSITORY COMPUTER-READABLE STORAGE MEDIUM STORING PROGRAM

(71) Applicant: TOYOTA JIDOSHA KABUSHIKI KAISHA, Toyota-shi (JP)

(72) Inventor: Katsuhiro MASUDA, Gifu-ken (JP)

(73) Assignee: TOYOTA JIDOSHA KABUSHIKI KAISHA, Toyota-shi (JP)

(21) Appl. No.: 18/915,660

(22) Filed: Oct. 15, 2024

(30) Foreign Application Priority Data
Nov. 30, 2023 (JP) 2023-202944

(51) Int. Cl. G06F 8/65

(52) U.S. Cl. CPC G06F 8/65

(57) ABSTRACT

A controller controls a display unit that displays information related to software updating, in which an updating process for software of an in-vehicle device set in a vehicle is executed in response to a predetermined operation performed to power off the in-vehicle device. The controller displays suspension information on the display unit indicating that the updating process is not being executed in a situation in which execution of the updating process is hampered when the predetermined operation is performed.

### CROSS-REFERENCE TO RELATED APPLICATIONS

This application is based upon and claims the benefit of priority from prior Japanese Patent Application No. 2023-202944, filed on Nov. 30, 2023, the entire contents of which are incorporated herein by reference.

### BACKGROUND

### 1. Field

The following description relates to a controller, a control method, and a non-transitory computer readable storage medium storing a program.

### 2. Description of Related Art

Vehicles include various types of in-vehicle devices that execute software to operate. Japanese Laid-Open Patent Publication No. 2022-163396 describes Over-the-Air (OTA) technology that downloads software from outside the vehicle through wireless communication to update software of an in-vehicle device in order to modify or add a vehicle functionality.

A software updating process may be executed after a power off operation is performed on the vehicle power. The software updating process, however, may be suspended for various reasons. If the updating process becomes suspended when the user is leaving the vehicle, the user may not be aware of such a situation and become confused when using the vehicle the next time.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a controller includes processing circuitry. The processing circuitry is configured to control a display unit that displays information related to software updating, in which an updating process for software of an in-vehicle device set in a vehicle is executed in response to a predetermined operation performed to turn off power of the in-vehicle device. Further, the processing circuitry is configured to display suspension information on the display unit indicating that the updating process is not being executed in a situation in which the execution of the updating process is hampered when the predetermined operation is performed.

In another general aspect, a control method includes controlling a display unit that displays information related to software updating, in which an updating process for software of an in-vehicle device set in a vehicle is executed in response to a predetermined operation performed to turn off power of the in-vehicle device, and displaying suspension information on the display unit indicating that the updating process is not being executed in a situation in which the execution of the updating process is hampered when the predetermined operation is performed.

In a further general aspect, a non-transitory computer-readable storage medium stores a program. The program when executed by a controller causes the controller to control a display unit that displays information related to software updating, in which an updating process for software of an in-vehicle device set in a vehicle is executed in response to a predetermined operation performed to turn off power of the in-vehicle device, and display suspension information on the display unit indicating that the updating process is not being executed in a situation in which the execution of the updating process is hampered when the predetermined operation is performed.

Other features and aspects will be apparent from the following detailed description, the drawings, and the claims.

### BRIEF DESCRIPTION OF THE DRAWINGS

FIG. 1 is a schematic diagram illustrating the configuration of a vehicle and a controller of a first embodiment.

FIG. 2 is a flowchart of a display control routine executed by the controller of the first embodiment.

FIG. 3 is a diagram showing one example of a guide information image displayed when updating is executed.

FIG. 4 is a diagram showing one example of a guide information image displayed when updating is completed.

FIG. 5 is a diagram showing one example of an image indicating suspension information.

FIG. 6 is a sequence diagram illustrating a processing flow related to information display control when an updating process is executed in a second embodiment.

FIG. 7 is a diagram showing one image example of guide information displayed when the updating process can be resumed after being suspended.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

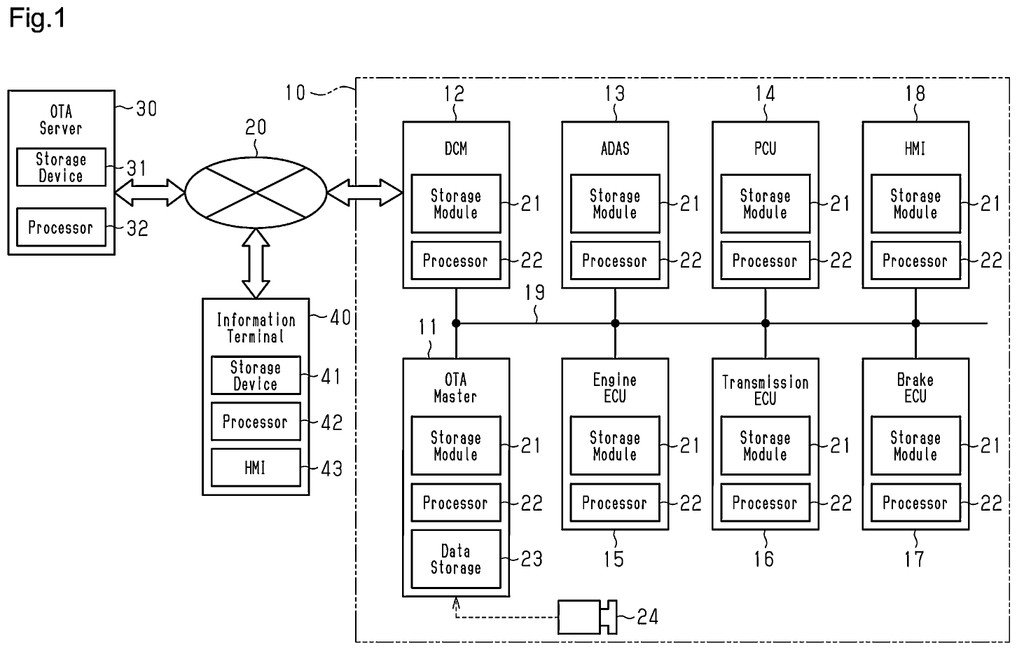

A controller, a control method, and a non-transitory computer-readable storage medium of a first embodiment will now be described in detail with reference to FIGS. 1 to 5.

### Configuration of Vehicle and Controller

The configuration of a vehicle and a controller in accordance with the present embodiment will now be described with reference to FIG. 1. A vehicle 10 shown in FIG. 1 includes in-vehicle devices, such as an Over-the-Air (OTA) master 11, a Data Communication Module (DCM) 12, an Advanced Driving Assistant System (ADAS) 13, a Power Control Unit (PCU) 14, an engine Electronic Control Unit (ECU) 15, a transmission ECU 16, a brake ECU 17, and a Human Machine Interface (HMI) 18. The HMI 18 is one example of a display unit. The in-vehicle devices are connected in a manner allowing for communication with one another through an in-vehicle network 19. The OTA master 11 governs the management of software updating for the in-vehicle devices including itself. The DCM 12 provides functionality for establishing wireless communication with the outside of the vehicle via a mobile communication network 20. In the present embodiment, the DCM 12 functions to record self-diagnosis results of each in-vehicle device of the vehicle 10 and send the self-diagnosis results to a datacenter or the like located outside the vehicle. The ADAS 13 is a system that provides advanced driving assistance functions such as those of an automatic braking device and a jackrabbit start prevention device. The PCU 14 controls electric power in the vehicle. The engine ECU 15 controls the engine. The transmission ECU 16 controls the transmission. The brake ECU 17 controls the brake. The HMI 18 includes an input device, which undergoes input operations performed by a vehicle occupant, and a display device, which presents information to the vehicle occupant through an image or a voice. The HMI 18 may also include a navigation function for guiding travel routes and an entertainment function for playing music and showing videos. These in-vehicle devices each include a storage module 21 that stores software and a processor 22 that executes the software. The OTA master 11 further includes data storage 23 that stores updated software acquired from outside the vehicle.

The vehicle 10 is operated in multiple power modes. The power modes include a travel power mode and a parked power mode. The in-vehicle device of which the power is to be turned on is designated for each power mode. When the travel power mode is set, the power is turned on for each in-vehicle device that is needed for the vehicle 10 to travel or to provide services for traveling. In the present embodiment, when the travel power mode is set, the power is turned on for all of the in-vehicle devices shown in FIG. 1. When the parked power mode is set, the power is turned on for only the in-vehicle devices that need to operate while the vehicle 10 is in a parked state. The in-vehicle device of which the power is turned on in each power mode may be changed by the user or be in accordance with the environment.

The vehicle 10 includes a power switch 24 used to switch between the travel power mode and the parked power mode. When the power switch 24 is switched off to switch from the travel power mode to the parked power mode. Further, the power switch 24 is switched on to switch from the parked power mode to the travel power mode. The power switch 24 may be referred to as an ignition switch in a conventional vehicle that uses only an engine as a drive source. The power switch 24 may be referred to as a ready switch in a motor-drive vehicle such as a battery electric vehicle (BEV) or a plug-in hybrid electric vehicle (PHEV).

Further, the power switch 24 of the vehicle 10 is used to switch the vehicle 10 between a power on state and a power off state. The vehicle 10 has a drive system that operates in a power on state and stops operating in a power off state.

The vehicle 10 is connected by the mobile communication network 20 to an OTA server 30. The OTA server 30 is a server device that distributes updated software to the in-vehicle devices. The OTA server 30 includes a storage device 31, which stores programs and data for distributing updated software, and a processor 32, which executes the distribution programs.

The mobile communication network 20 connects the OTA server 30 to an information terminal 40 of the user of the vehicle 10 in a manner allowing for communication. One example of the information terminal 40 is a smartphone. The information terminal 40 may be a tablet terminal or a personal computer terminal. The information terminal 40 includes a storage device 41, a processor 42, and an HMI 43. The processor 42 reads and executes software stored in the storage device 41. The HMI 43 includes an input device, which undergoes input operations performed by the user, and a display device, which presents information to the user. The software stored in the storage device 41 includes software that implements functionality for viewing information of the vehicle 10 owned by the user or functionality for performing a remote operation.

### Outline of Software Updating

Software updating of in-vehicle devices in the vehicle 10 will now be outlined. The in-vehicle devices that are subject to software updating include the OTA master 11, the DCM 12, the ADAS 13, the PCU 14, the engine ECU 15, the transmission ECU 16, the brake ECU 17, and the HMI 18. Software updating is performed through a downloading phase, an installation phase, and an activation phase.

In the downloading phase, the OTA server 30 transmits updated software to the vehicle 10. The OTA master 11 stores the updated software received from the OTA server 30 in the data storage 23. The download phase includes a series of processes related to downloading, such as determination of whether to perform downloading and verification of updating data. The transmission of the updated software from the OTA server 30 to the OTA master 11 may be performed by compressing the updated software and sending the compressed data or by dividing the updated software or compressed data into data segments and sending the data segements. Further, updated software for multiple in-vehicle devices may be transmitted at the same time.

In the installation phase, updated software is installed in each in-vehicle device that is subject to updating. In the installation phase, based on the updating data that has been downloaded to the data storage 23, the OTA master 11 installs the updated software in the storage module 21 of the in-vehicle device that is subject to updating. The installation phase includes a series of processes related to installing, such as determination of whether to perform installing, the transfer of the updating data, and the verification of the updated software. When the updating data includes the updated software, in the installation phase, the OTA master 11 transfers the updating data to the in-vehicle device that is subject to updating. When the updating data includes compressed data, differential data, or data segments of the updated software, a generation process is performed to generate the updated software from the updating data. The generation process may be performed by the OTA master 11 or by the in-vehicle device that is subject to updating. The generation of the updated software is performed by de-compressing the compressed data or by reassembling the differential data or data segments. When the installation phase is completed, the updated software is set as invalid.

During the activation phase, in the in-vehicle device that is subject to updating, the updated software is activated, that is, the updated software is validated. The activation phase includes a series of processes related to activation, such as determination of whether to execute activation, checking whether the updated software is correct, and verification of the activation result.

Depending on the hardware configuration or software type of the in-vehicle device, the software updating process may be executed when a power off operation is performed on the vehicle 10. In the present embodiment, the updating process includes both the installation phase and the activation phase. The updating process may be a process that includes only one of the installation phase and the activation phase.

When the downloading phase is completed, the OTA master 11 inquires the user, via the HMI 18, whether the updating process can be executed after the next power off operation is performed. In response to the inquiry, if the user approves the execution of the updating process and then a power off operation is performed on the vehicle 10, the OTA master 11 starts the updating process. The in-vehicle device that starts the updating process is an in-vehicle device that is powered off when a power off operation is performed on the vehicle 10. In the present embodiment, an operation for turning off power of the vehicle 10 corresponds to a predetermined operation powering off the in-vehicle device that is to undergo the execution of software updating.

Depending on the situation, the execution of the updating process may be hampered when a power off operation is performed on the vehicle 10. A situation in which the updating process is hampered is, for example, a situation in which the in-vehicle device subject to updating cannot be powered off even after a power off operation is been performed on the vehicle 10. Specific examples of such situations will be described below as situations (A) to (C).

Situation (A) is a situation in which the execution of a software updating process is hampered when hill hold control is being executed on the vehicle 10 that has been stopped on a hill. When the vehicle 10 is stopped on a hill having a large gradient, the vehicle 10 may start rolling if, for example, the parked brake is not applied effectively. When movement of the vehicle 10 stopped on a hill is detected, the vehicle 10 may be controlled to actuate the hydraulic brake or steering system so that the vehicle 10 does not roll. Such hill hold control is executed when the vehicle 10 is stopped on a hill that satisfies a specified condition. One example of the specified condition is the gradient of the hill on which the vehicle 10 is stopped being a specified value or greater. When the hill hold control is being executed, an in-vehicle device related to the execution of the hill hold control will continue to be actuated even after a power off operation is performed on the vehicle 10. When the hill hold control is being executed, there may be a case in which the software updating process cannot be executed on the in-vehicle device related to the hill hold control. To complete the installation phase and the activation phase during the updating process, the in-vehicle device needs to be powered off and re-booted. When the hill hold control is being executed, an in-vehicle device that is related to the hill hold control cannot be powered off even after a power off operation is performed on the vehicle 10. Thus, the updating process cannot be performed on such an in-vehicle device. An in-vehicle device related to the execution of the hill hold control includes, for example, an in-vehicle device that monitors movement of the stopped vehicle 10 and an in-vehicle device that brakes or steers the vehicle 10. The in-vehicle devices in FIG. 1 that are related to the hill hold control are the ADAS 13 and the brake ECU 17.

Situation (B) is a situation in which the execution of an updating process is hampered by an emergency notification system of the vehicle 10. The emergency notification system monitors the vehicle 10 when in a parked state and sends a notification to the outside of the vehicle when an anomaly occurs. During actuation of the emergency notification system, even after a power off operation is performed on the vehicle 10, an in-vehicle device that is related to actuation of the emergency notification system cannot be powered off and will continue to operate. Thus, software updating cannot be executed. The in-vehicle devices in FIG. 1 that are related to actuation of the emergency notification system are the DCM 12 and the ADAS 13. The emergency notification system is actuated by the user.

Situation (C) is a situation in which the execution of an updating process is hampered by the power setting of the HMI 18 during a period in which the vehicle 10 is powered off. The HMI 18 is configured to switch its power setting, after a power off operation is performed on the vehicle 10, between a first state and a second state. The first state is a sleep state to which the HMI 18 shifts after a power off operation is performed on the vehicle 10. In the sleep state, the HMI 18 darkens its display but keeps some of its functions active in order to show information on the display in response to, for example, a command from an external device. The second state is a shutdown state in which the HMI 18 is powered off in response to a power off operation performed on the vehicle 10. In the shutdown state, the HMI 18 cannot show information in its display. The HMI 18 is configured to allow such power setting to be switched by the user. In the present embodiment, when a software updating process is executed in response to a power off operation performed on the vehicle 10, update-related information is displayed on the HMI 18. When the power setting is in the second state (shutdown state), the HMI 18 cannot display information during an updating process. Thus, execution of the updating process in response to a power off operation performed on the vehicle 10 is restricted when the power setting of the HMI 18 is in the second state.

### Display Control of Information Related to Updating Process

The OTA master 11 executes display control for displaying information on the HMI 18 during an updating process. The display control will now be described in detail.

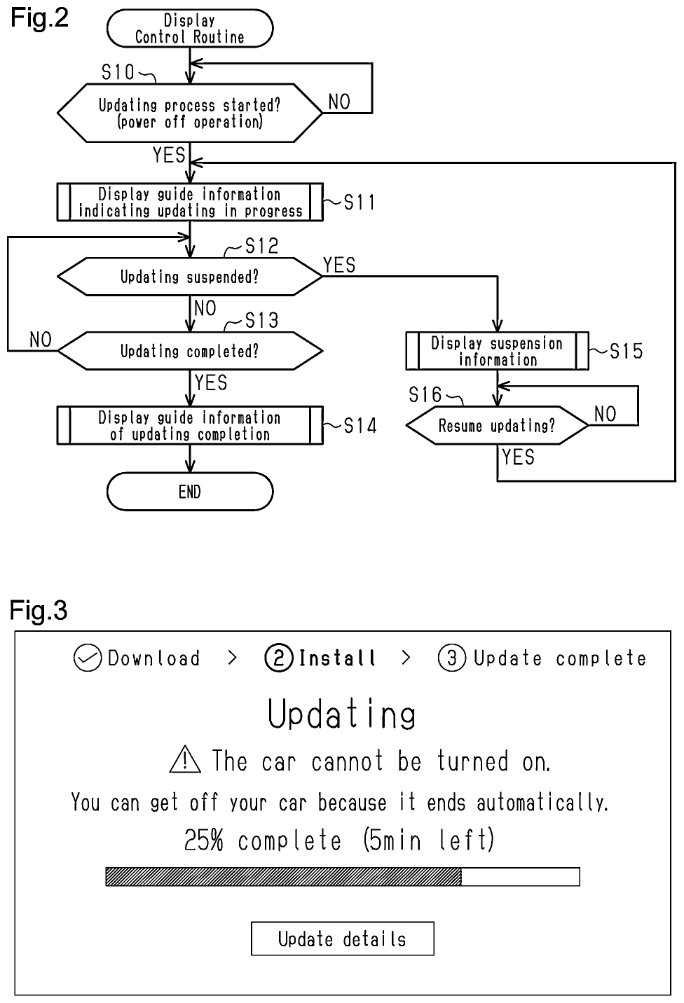

FIG. 2 shows the processing procedures of a display control routine performed by the OTA master 11 to execute the display control for displaying information corresponding to an updating process. The OTA master 11 initiates the routine when the user permits execution of the updating process.

After initiating the routine, the OTA master 11 waits until an updating process is started when a power off operation is performed on the vehicle 10 (S10). When an updating process is started (S10: YES), the OTA master 11 displays guide information on the HMI 18 to indicate that the updating process is being executed (S11). When the updating process is completed (S13: YES), the OTA master 11 displays guide information on the HMI 18 indicating that the updating process has been completed (S14), and then ends the routine.

When execution of an updating process is suspended due to a situation hampering the updating process (S12: YES), the OTA master 11 displays suspension information on the HMI 18 to indicate that the updating process is not being executed (S15). Then, the OTA master 11 waits until the situation is resolved and the updating process is resumed (S16). When the updating process is resumed (S16: YES), the OTA master 11 returns to step S11. In this case, in step S11 of FIG. 2, the OTA master 11 displays guide information on the HMI 18 indicating that the updating process is being executed. By looking at the guide information after looking at the suspension information, the user can recognize that the updating process, which was suspended, is now executable. In this manner, in the present embodiment, when a situation hampering execution of the updating process is resolved after the suspension information is displayed, the information displayed on the HMI 18 is changed from the suspension information to the guide information indicating that the updating process is now executable.

A situation hampering execution of the updating process may already be occurring at the moment a power off operation is performed on the vehicle 10. In such a case, the OTA master 11 displays suspension information on the HMI 18 without starting the updating process.

FIG. 3 shows one example of an image including guide information indicating that an updating process is being executed. The image of FIG. 3 shows the guide information indicating that the updating process is being executed together with information indicating progress of the updating process. The image of FIG. 3 also shows information notifying the user that a power on operation cannot be performed on the vehicle 10 until the updating process is completed.

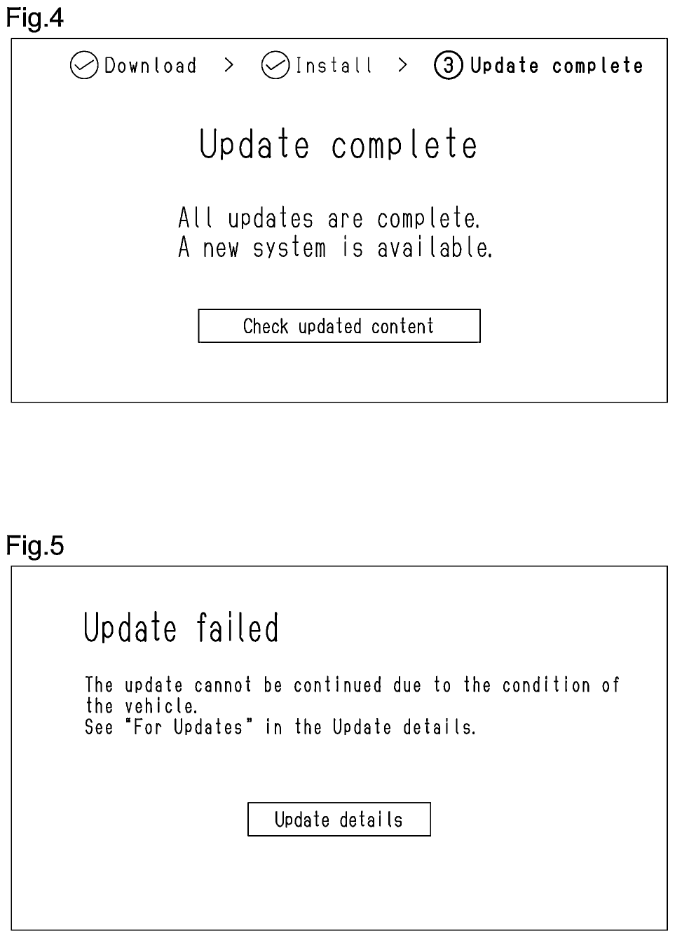

FIG. 4 shows one example of an image including guide information indicating that the updating process has been completed. The image of FIG. 4 shows the guide information indicating that the updating process has been completed in addition to information notifying the user that the functions of the updated in-vehicle device can now be implemented. Further, the image of FIG. 4 shows a button that can be pressed to view detailed information of the updated software.

FIG. 5 shows one example of an image including suspension information indicating that the updating process cannot be executed. The image of FIG. 5 shows the suspension information together with a button that can be pressed to view more detailed information. When the button is pressed, more detailed suspension information is displayed on the HMI 18. The information displayed in this case includes information indicating why the updating process was suspended and information indicating the user operation performed to resume the updating process. For example, in situation (A), the HMI 18 displays detailed information indicating that execution of an updating process is being hampered because the vehicle 10 is stopped on a hill having a steep gradient and that the updating process can be resumed by parking the vehicle 10 at a level location. In situation (B), the HMI 18 displays detailed suspension information indicating that execution of an updating process is being hampered because the emergency notification system has been activated and that the updating process can be resumed by deactivating the emergency notification system. In situation (C), the HMI 18 displays detailed suspension information indicating that execution of an updating process is being hampered because the power setting of the HMI 18 is in the shutdown state and that the updating process can be resumed by switching the power setting to the sleep state.

### Operation and Advantages of Embodiment

The advantages of the embodiment will now be described.

The OTA master 11 starts an updating process in response to a power off operation performed on the vehicle 10. When the updating process is started, the OTA master 11 displays guide information on the HMI 18 indicating that the updating process is being executed. When the updating process is completed, the OTA master 11 displays guide information on the HMI 18 indicating that the updating process has been completed.

When a situation hampering the execution of the updating process occurs, the execution of the updating process will be suspended. In this case, the OTA master 11 displays suspension information on the HMI 18 indicating that the updating process is not being executed. This allows the user to recognize that the updating process has been suspended. When the updating process is suspended, the OTA master 11 displays information on the HMI 18 indicating why the updating process has been suspended and indicating how to resume the updating process. The user can perform the operation indicated in the displayed information to resume the updating process.

The present embodiment has the advantages described below. [0057](1) The OTA master 11 updates software of an in-vehicle device by executing a process for updating the software of the in-vehicle device in response to a predetermined operation performed to power off the in-vehicle device. When the predetermined operation is performed but a situation hampering execution of the updating process is occurring, the OTA master 11 displays the suspension information on the HMI 18 indicating that the updating process is not being executed. Thus, when software updating of the in-vehicle device is suspended, the user will readily recognize such situation. [0058](2) When the situation hampering execution of the updating process is resolved after the suspension information is displayed, the OTA master 11 changes the information displayed on the HMI 18 from the suspension information to guide information indicating that the updating process is now executable. Thus, when the updating process that was suspended becomes executable, the user will readily recognize such a situation. [0059](3) The OTA master 11 displays detailed suspension information on the HMI 18 indicating the content of the situation hampering execution of the updating process and information indicating how to resolve such situation. This allows the user to readily resume the updating process.

### Second Embodiment

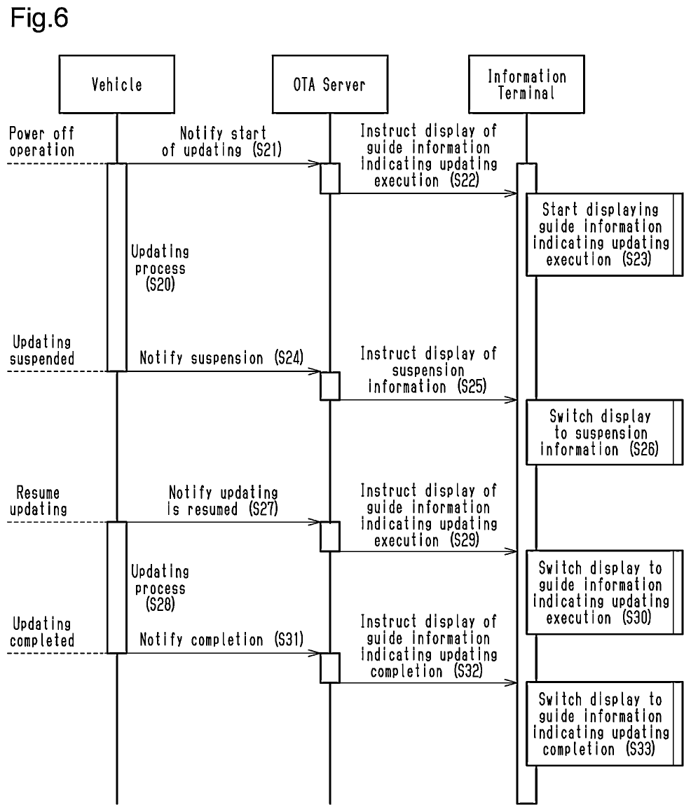

A controller, a control method, and a program of a second embodiment will now be described in detail with reference to FIG. 6. The same reference numerals are given to those components that are the same as the corresponding components of the first embodiment. Such components will not be described in detail.

In the first embodiment, the OTA master 11 displays information related to an updating process on the HMI 18, which is set in the vehicle 10. In the present embodiment, the information related to the updating process is displayed on the HMI 43 of the information terminal 40, which is owned by the user of the vehicle 10. Such display control is executed by the OTA server 30 of the datacenter.

FIG. 6 shows the flow of a process related to the display control of information related to an updating process in the present embodiment. As shown in FIG. 6, an updating process of an in-vehicle device is started in response to a power off operation performed on the vehicle 10 (S20). The vehicle 10 notifies the OTA server 30 that the updating process has been started (S21). In response to the notification, the OTA server 30 instructs the information terminal 40 to display guide information indicating that the updating process is being executed (S22). In response to the instruction, the information terminal 40 starts displaying the guide information (S23). The information terminal 40 displays an image similar to that shown in FIG. 3.

Then, in FIG. 6, a situation hampering execution of the updating process occurs in the vehicle 10. This suspends the updating process. In this case, the vehicle 10 notifies the OTA server 30 that the updating process has been suspended (S24). In response to the notification, the OTA server 30 instructs the information terminal 40 to display suspension information (S25). In response to the instruction, the information terminal 40 switches the displayed information from the guide information to the suspension information (S26). The information terminal 40 displays an image similar to that shown in FIG. 5.

Subsequently, the vehicle 10 resumes the updating process (S28). In this case, the vehicle 10 notifies the OTA server 30 that the updating process has been resumed (S27). In response to the notification, the OTA server 30 notifies the information terminal 40 to display information indicating that the updating process is being executed (S29). In response to the instruction, the information terminal 40 switches the displayed information from the suspension information to guide information indicating that the updating process is being executed (S26).

In FIG. 6, the updating process is continued until it is completed. When the updating process is completed, the vehicle 10 notifies the OTA server 30 that the updating process has been completed (S31). In response to the notification, the OTA server 30 instructs the information terminal 40 to display guide information indicating that the updating process has been completed (S32). In response to the instruction, the information terminal 40 switches the displayed information to guide information indicating that the updating process has been completed (S33).

The present embodiment allows the user to view information related to an updating process with the information terminal 40. The present embodiment has the same advantages as the first embodiment. The control of the present embodiment for displaying information on the information terminal 40 may be executed together with the control of the first embodiment for displaying information on the HMI 18 of the vehicle 10.

### Other Embodiments

The above embodiments may be modified as described below. The above embodiments and the modified examples described below may be combined as long as there is no technical contradiction.

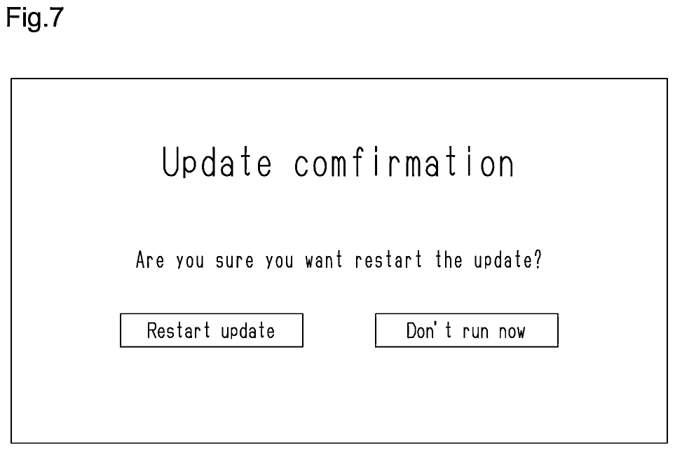

The user may be requested to give permission for resuming an updating process that has been suspended. In this case, when a situation hampering execution of the updating process is resolved, an image such as that shown in FIG. 7 may be displayed on the HMI 18 or the information terminal 40 to inquire whether the user wishes to resume the updating process. The display of such a display allows the user to view that the updating process that has been suspended is now executable. The image for inquiring whether the user wishes to resume the updating process includes guide information indicating that the updating process is now executable.

The examples of the displayed images shown in FIGS. 3 to 5 and 7 use text to indicate information. Instead of using text, the images may use other representations expressing information such as still pictures or dynamic pictures.

The suspension information may include one of or both of information indicating the content of the situation hampering the execution of an updating process and information indicating how to resolve such a situation. The suspension information includes at least information indicating that an updating process is not being executed.

The OTA master 11, which manages software updating, controls the display of information related to software updating. The management of software updating and the display control of information related to software updating may be performed by different in-vehicle devices. For example, the information display control of the HMI 18 in the first embodiment may be performed by an in-vehicle device that is subject to software updating.

In the above embodiments, the power of the in-vehicle device undergoing the software updating process is turned off when an operation for turning off the power switch 24 of the vehicle 10 is performed. An in-vehicle device may be configured to be powered off in response to a different operation. For example, the vehicle 10 may have three power modes, namely, a mode corresponding to an ignition (IG) on state, a mode corresponding to an accessory (ACC) power on state, and a mode corresponding to a vehicle power off state.

In the IG on state, the vehicle engine is running, and multiple ECUs are powered on. In the ACC power on state, only some of the ECUs are powered on. This differs from the IG on state. In the vehicle power off state, substantially all of the ECUs are powered off. In this case, in an in-vehicle device that is powered off in response to a switching operation performed to switch from the IG on state to the ACC power on state, the software updating process may be started in response to the switching operation. If a situation hampering the execution of the updating process occurs when a switching operation is performed to switch from the IG on state to the ACC power on state, the display of suspension information will allow the user to readily recognize such situation. When a software updating process of an in-vehicle device is executed in response to the predetermined operation performed to power off the in-vehicle device, the suspension information may be displayed if a situation hampering execution of the updating process occurs when the predetermined operation is performed.

The controller may be configured as processing circuitry including one or more processors that run on computer programs, one or more dedicated hardware circuits such as dedicated hardware that execute at least some of the processes, or a combination of processors and hardware circuits. Examples of dedicated hardware include an Application Specific Integrated Circuit (ASIC). The processors include a central processing unit (CPU) and a memory such as a random-access memory (RAM) and a read-only memory (ROM), and the memory stores program codes or instructions configured to have the CPU execute processes. The memory, namely, a computer-readable medium, includes any available medium that is accessible by a versatile or special-purpose computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller, comprising:
processing circuitry, wherein
the processing circuitry is configured to control a display unit that displays information related to software updating, in which an updating process for software of an in-vehicle device set in a vehicle is executed in response to a predetermined operation performed to power off the in-vehicle device, and
the processing circuitry is configured to display suspension information on the display unit indicating that the updating process is not being executed in a situation in which execution of the updating process is hampered when the predetermined operation is performed.

2. The controller according to claim 1, wherein the predetermined operation is an operation for turning off power of the vehicle.

3. The controller according to claim 1, wherein when the suspension information is displayed on the display unit and the situation hampering execution of the updating process is then resolved, the processing circuitry is configured to change the suspension information displayed on the display unit to guide information indicating that the updating process is executable.

4. The controller according to claim 1, wherein the situation hampering execution of the updating process is a situation in which the in-vehicle device cannot be powered off after the predetermined operation is performed.

5. The controller according to claim 1, wherein the situation hampering execution of the updating process is a situation in which the vehicle is stopped on a hill satisfying a specified condition.

6. The controller according to claim 5, wherein the in-vehicle device is a brake electronic control unit configured to execute a process related to a brake operation after the predetermined operation is performed when the vehicle is stopped on a hill satisfying the specified condition.

7. The controller according to claim 1, wherein the situation hampering execution of the updating process is a situation in which an emergency notification system of the vehicle is activated.

8. The controller according to claim 1, wherein
the display unit is configured to be switchable between a first state in which display of information is enabled after the predetermined operation is performed and a second state in which display of information is disabled after the predetermined operation is performed, and the situation hampering execution of the updating process is a situation in which the display unit is set to the second state.

9. The controller according to claim 8, wherein the display unit is configured to be switched between the first state and the second state by a user of the vehicle.

10. The controller according to claim 1, wherein the suspension information includes information indicating a content of the situation hampering execution of the updating process.

11. The controller according to claim 1, wherein the suspension information includes information indicating how to resolve the situation hampering execution of the updating process.

12. A control method, comprising:
controlling a display unit that displays information related to software updating, in which an updating process for software of an in-vehicle device set in a vehicle is executed in response to a predetermined operation performed to power off the in-vehicle device; and
displaying suspension information on the display unit indicating that the updating process is not being executed in a situation in which execution of the updating process is hampered when the predetermined operation is performed.

13. A non-transitory computer-readable storage medium storing a program, the program, when executed by a controller, causes the controller to:
control a display unit that displays information related to software updating, in which an updating process for software of an in-vehicle device set in a vehicle is executed in response to a predetermined operation performed to power off the in-vehicle device; and
display suspension information on the display unit indicating that the updating process is not being executed in a situation in which execution of the updating process is hampered when the predetermined operation is performed.
